(19) United States
(12) Patent Application Publication
(10) Pub. No.: US 2019/0228369 A1
(43) Pub. Date: Jul. 25, 2019

(54) PEER-BASED TRANSACTION VERIFICATION

(71) Applicant: Nathanael K. Duval-Igarta, Bonney Lake, WA (US)

(72) Inventor: Nathanael K. Duval-Igarta, Bonney Lake, WA (US)

(21) Appl. No.: 15/972,579

(22) Filed: May 7, 2018

Related U.S. Application Data
(60) Provisional application No. 62/621,789, filed on Jan. 25, 2018.

(51) Int. Cl. G06Q 10/06; G06Q 40/02; G06Q 30/02

(52) U.S. Cl. CPC G06Q 10/063114; G06Q 30/0282; G06Q 40/02

(57) ABSTRACT

Methods, systems, and devices for peer verification of task completion are described. Employers may wish to verify a person's work history. A peer validation system may be used to verify a work transaction or a potential contractor's work history. Documents may be submitted to multiple peers, who may verify them. Based on the feedback from multiple peers, the transaction may be validated and a credit score may be updated for the person who completed the work. After multiple successful validations and history of use, a user may accrue a sufficiently large credit score to signal validate their skill and reliability.

### CROSS-REFERENCE TO RELATED APPLICATION

This application claims priority to, and the benefit of, U.S. Provisional Application Ser. No. 62/621,789 filed on 25 Jan. 2018, entitled PEER-BASED TRANSACTION VERIFICATION. The entire contents of the foregoing application are hereby incorporated by reference for all purposes.

### BACKGROUND

The following relates generally to verifying task completion, and more specifically to peer verification of task completion.

Different mechanisms exist to coordinate and supervise work. For example, many firms employ supervisors to distribute tasks to employees and verify that the work is done properly. The employees are often selected based on qualifications, credentials, and prior work history. In another example, in what is often known as the freelance or ‘gig’ economy, an employer may make short term contracts for discrete tasks to be accomplished by independent contractors.

As telecommunications technology such as the internet makes remote work possible for an increasing portion of workers, the need to verify satisfactory completion of individual tasks, and compile information about the overall skill and reliability for remote workers becomes more and more pressing. However, for some kinds of work arrangements, direct supervision of laborers using a hierarchy of supervisors is inefficient or impractical.

### SUMMARY

A peer validation system may be used to verify a work transaction or a potential contractor's work history. Documents may be submitted to multiple peers, who may verify them. Based on the feedback from multiple peers, the transaction may be validated and a credit score may be updated for the person who completed the work. After multiple successful validations and history of use, a user may accrue a sufficiently large credit score to signal validate their skill and reliability.

In one embodiment, a method may include identifying one or more documents indicating that a transaction is complete, transmitting the one or more documents to a plurality of peers, receiving a plurality of feedback indicators from the plurality of peers based on the one or more documents, wherein at most one of the plurality of feedback indicators is received from each of the plurality of peers, determining an update factor based on the plurality of feedback indicators, and updating a credit score of a user based on the update factor.

In one embodiment, a non-transitory computer-readable medium may include instructions operable to cause a processor to identify one or more documents indicating that a transaction is complete, transmit the one or more documents to a plurality of peers, receive a plurality of feedback indicators from the plurality of peers based on the one or more documents, wherein at most one of the plurality of feedback indicators is received from each of the plurality of peers, determine an update factor based on the plurality of feedback indicators, and update a credit score of a user based on the update factor.

In one embodiment, an apparatus may include a processor, memory in electronic communication with the processor, and instructions stored in the memory. The instructions may be operable to cause the processor to identify one or more documents indicating that a transaction is complete, transmit the one or more documents to a plurality of peers, receive a plurality of feedback indicators from the plurality of peers based on the one or more documents, wherein at most one of the plurality of feedback indicators is received from each of the plurality of peers, determine an update factor based on the plurality of feedback indicators, and update a credit score of a user based on the update factor.

In one embodiment, an apparatus may include means for identifying one or more documents indicating that a transaction is complete, means for transmitting the one or more documents to a plurality of peers, means for receiving a plurality of feedback indicators from the plurality of peers based on the one or more documents, wherein at most one of the plurality of feedback indicators is received from each of the plurality of peers, means for determining an update factor based on the plurality of feedback indicators, and means for updating a credit score of a user based on the update factor.

In some examples of the method, non-transitory computer-readable medium, and apparatus described above, each of the plurality of peers may have a corresponding credit score.

Some examples of the method, non-transitory computer-readable medium, and apparatus described above may further include processes, features, means, or instructions for determining a validation factor for a peer of the plurality of peers based at least in part on the plurality of feedback indicators. Some examples of the method, non-transitory computer-readable medium, and apparatus described above may further include processes, features, means, or instructions for updating the corresponding credit score for the user based on the validation factor.

In some examples of the method, non-transitory computer-readable medium, and apparatus described above, the validation factor for the user may be based on whether a feedback indicator received from the user may be consistent with other feedback indicators of the plurality of feedback indicators.

In some examples of the method, non-transitory computer-readable medium, and apparatus described above, the transaction comprises a task, a job, a gig, a sales transaction, a project, or any combination thereof. In some examples of the method, non-transitory computer-readable medium, and apparatus described above, the one or more documents comprise one or more photographs, digital images, text documents, or any combination thereof.

Some examples of the method, non-transitory computer-readable medium, and apparatus described above may further include processes, features, means, or instructions for displaying a plurality of feedback options to the plurality of peers, wherein the plurality of feedback options comprises an approve option, a reject option, a decline option, a report option, or any combination thereof, and wherein each of the plurality of feedback indicators corresponds to one of the plurality of feedback options.

In some examples of the method, non-transitory computer-readable medium, and apparatus described above, the plurality of feedback indicators comprise a number of approve indicators and a number of reject indicators, and wherein the update factor may be based on a comparison of the number of approve indicators and the number of reject indicators.

Some examples of the method, non-transitory computer-readable medium, and apparatus described above may further include processes, features, means, or instructions for determining a number of feedback indicators received from a peer of the plurality of peers during a time period, wherein the one or more documents may be transmitted to the user based at least in part on the number of feedback indicators received from the user during the time period.

Some examples of the method, non-transitory computer-readable medium, and apparatus described above may further include processes, features, means, or instructions for identifying a category of the transaction, wherein the plurality of peers may be selected based at least in part on the category.

Some examples of the method, non-transitory computer-readable medium, and apparatus described above may further include processes, features, means, or instructions for determining the credit score based at least in part on a time period for using an application, a validation history, a number of accounts, a number of completed transactions, a set of transaction categories, or any combination thereof.

Some examples of the method, non-transitory computer-readable medium, and apparatus described above may further include processes, features, means, or instructions for identifying a description of the transaction. Some examples of the method, non-transitory computer-readable medium, and apparatus described above may further include processes, features, means, or instructions for transmitting the description to the plurality of peers, wherein the plurality of feedback indicators may be based at least in part on the description.

Some examples of the method, non-transitory computer-readable medium, and apparatus described above may further include processes, features, means, or instructions for determining a provisional update factor based on transaction. Some examples of the method, non-transitory computer-readable medium, and apparatus described above may further include processes, features, means, or instructions for determining a provisional credit score for the user based on the provisional update factor. Some examples of the method, non-transitory computer-readable medium, and apparatus described above may further include processes, features, means, or instructions for displaying the provisional credit score to the user prior to updating the credit score based on the update factor.

Some examples of the method, non-transitory computer-readable medium, and apparatus described above may further include processes, features, means, or instructions for recording the transaction among a block of transactions in a ledger.

In some examples of the method, non-transitory computer-readable medium, and apparatus described above, the ledger comprises a centralized ledger. In some examples of the method, non-transitory computer-readable medium, and apparatus described above, the ledger comprises a decentralized ledger. In some examples of the method, non-transitory computer-readable medium, and apparatus described above, the block of transactions comprises a merkle tree of hashed transactions.

Some examples of the method, non-transitory computer-readable medium, and apparatus described above may further include processes, features, means, or instructions for identifying a feedback threshold for a time period. Some examples of the method, non-transitory computer-readable medium, and apparatus described above may further include processes, features, means, or instructions for determining a feedback number based on a number of feedback indications, a number of approve indications, a number of reject indications, or any combination thereof provided by the user during the time period. Some examples of the method, non-transitory computer-readable medium, and apparatus described above may further include processes, features, means, or instructions for determining whether the feedback number exceeds the feedback threshold. Some examples of the method, non-transitory computer-readable medium, and apparatus described above may further include processes, features, means, or instructions for selecting an activity status for the user based at least in part on whether the feedback number exceeds the feedback threshold.

Some examples of the method, non-transitory computer-readable medium, and apparatus described above may further include processes, features, means, or instructions for adjusting the credit score based on the activity status.

Some examples of the method, non-transitory computer-readable medium, and apparatus described above may further include processes, features, means, or instructions for identifying one or more target documents and a target time period. Some examples of the method, non-transitory computer-readable medium, and apparatus described above may further include processes, features, means, or instructions for transmitting the one or more target documents to one or more candidate users. Some examples of the method, non-transitory computer-readable medium, and apparatus described above may further include processes, features, means, or instructions for receiving the one or more documents within the target time period in response to transmitting the one or more target documents, and wherein the feedback indicators represent feedback regarding whether the one or more documents match the one or more target documents.

Some examples of the method, non-transitory computer-readable medium, and apparatus described above may further include processes, features, means, or instructions for identifying a threshold number of transactions for the user. Some examples of the method, non-transitory computer-readable medium, and apparatus described above may further include processes, features, means, or instructions for identifying a number of transactions posted for review for the user during a time period. Some examples of the method, non-transitory computer-readable medium, and apparatus described above may further include processes, features, means, or instructions for verifying whether the number of transactions exceeds the threshold number of transactions, wherein transmitting the one or more documents may be based at least in part on the verification.

Some examples of the method, non-transitory computer-readable medium, and apparatus described above may further include processes, features, means, or instructions for determining that a verification time period may have passed after transmitting the one or more documents, wherein determining the update factor may be based at least in part on determining that the verification time period may have passed.

Some examples of the method, non-transitory computer-readable medium, and apparatus described above may further include processes, features, means, or instructions for determining that a threshold number of the plurality of feedback indicators may have been received, wherein determining the update factor may be based at least in part on determining that the threshold number of the plurality of feedback indicators may have been received.

### BRIEF DESCRIPTION OF THE DRAWINGS

FIG. 1 illustrates an example of a centralized credit network that supports peer verification of task completion in accordance with aspects of the present disclosure.

FIG. 2 illustrates an example of a decentralized credit network that supports peer verification of task completion in accordance with aspects of the present disclosure.

FIG. 3 illustrates an example of a validation node that supports peer verification of task completion in accordance with aspects of the present disclosure.

FIGS. 4 through 8 illustrate examples of processes performed by a validation node for peer verification of task completion in accordance with aspects of the present disclosure.

### DETAILED DESCRIPTION

A peer validation system may be used to verify a work transaction or a potential contractor's work history. Documents may be submitted to multiple peers, who may verify them. Based on the feedback from multiple peers, the transaction may be validated and a credit score may be updated for the person who completed the work. After multiple successful validations and history of use, a user may accrue a sufficiently large credit score to signal validate their skill and reliability.

To begin the process, a user may log in to an application on their dedicated or general purpose computing device such as a mobile communications device. Upon logging in, the user may be presented with a menu interface. The menu interface may provide options including a “build” option, a “validate” option, a “portfolio” option, a “stake” option”, and a “settings” option. A user may select an option to “build”. Upon doing so, a user may select a category describing a task they have previously completed. These categories may include sales, operations, volunteer work, or others. A user may then upload one or more documents and a description describing a task they have completed. The uploaded documents may include pictures, premade forms, or others.

In some cases, this may lead to an instant increase in the user's credit score. In other cases, the uploaded documents may be sent to the validation component, where other users may review them and help determine if the task transaction is valid. A user may select an option to “validate”. Upon doing so, a user may be presented with peer user's proposed transaction, which may include pictures or documents describing what the peer asserts they have completed. When evaluating a peer's proposed transaction, the user may be prompted to validate with different options. The validation options may include “approve”, “reject”, “decline”, “report”, or others. In some cases, a simple majority vote from a multitude of peers on one option within a time period may decide if the transaction is validated. A user may increase their credit score by continually voting on other peer's proposed transactions.

In some cases, a user (User A) may be limited to a number of total pictures submitted/posted for reviewals per month unless subscription is paid. In some cases, validation rules may include: once a photo or document has obtained, either 51% of the total users votes or, if 8 day time limit is expired, then to 51% of the total votes then validation is complete. In some cases, a plurality of peers will be restricted to “Approving” or “Rejecting” a specific amount of photos per day which may calculate to, for example, 27% of the amount of users in each Approving or Rejecting category.

In one example, a network of 50 users participates in voting on a proposed transaction. The voting time from the original submission is 8 days. At the end of the 8th day, 35 users have voted on the proposed transactions. The votes consist of 18 “approve” votes and 17 “reject” votes. The transaction is complete, with a result of “approve”. This transaction is then added to the open ledger, and the user who submitted the proposal will have their credit score increased.

A user may select an option to “stake”. In some cases, only users with special permissions may choose the “stake” option. Upon doing so, the user may be presented with an interface to construct a task for peers to complete. The user may choose a time limit for the task, a voting time for once the proposed transaction is submitted, a multiplier for the credit score reward upon an approved transaction, a priority level, or other parameters. A user may select a “settings” option. Upon doing so the user may alter the visual appearance of their interface or change functionality.

In one staking variation, an admin and or a user may have a separate log ins than a set of other users. The user may take a photo of documents and send to specific and/or all peers on the given network with a specific time limit and request. At which point, the first peer user is successful at completing the task, said user will take a picture of identical document and submit with description proof, at which point the “staked” document and a users proof will be sent together to the rest of the users and up for the same validation system we have prior discussed. This system may be used to allow management to send out an objective and see who can obtain it the quickest and obtain validation from peers.

A second variation may be similar to the first variation in some aspects, but users may be able to replicate the same concept as above, but with each other. That is, a user (for example, in upper management) sending it out to a front line team.

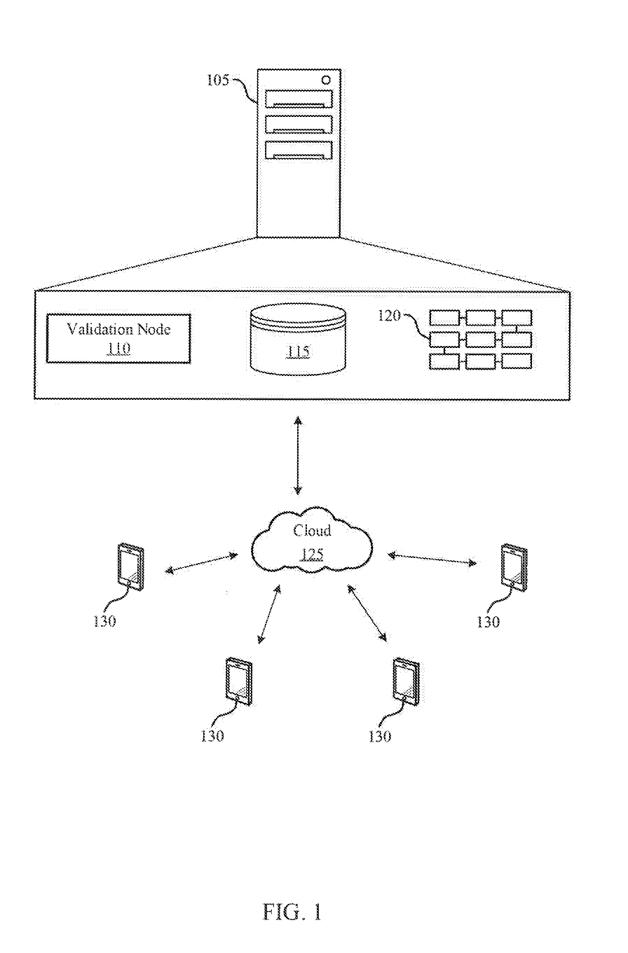

FIG. 1 illustrates an example of a centralized credit network that supports peer verification of task completion in accordance with aspects of the present disclosure. FIG. 1 includes illustrations of validation server 105, cloud 125, and user devices 130. In a centralized network, validation and maintenance of credit ratings is controlled by a centralized validation server 105.

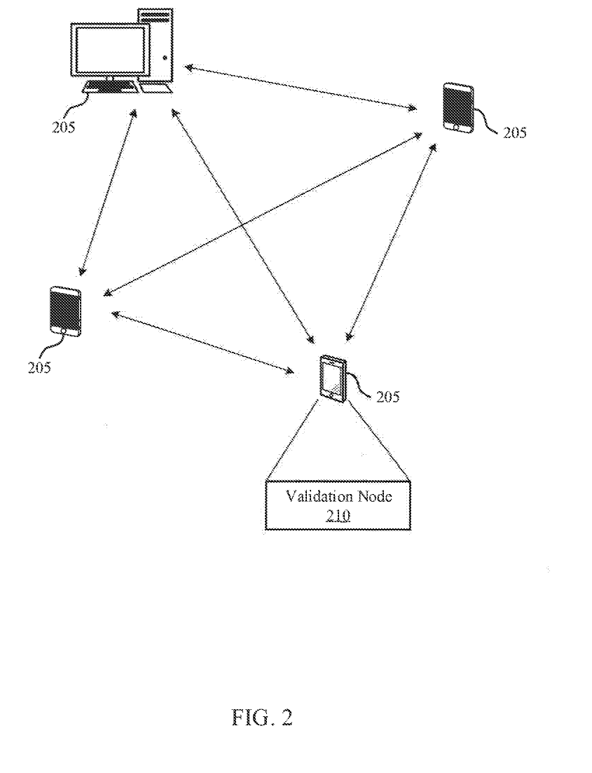

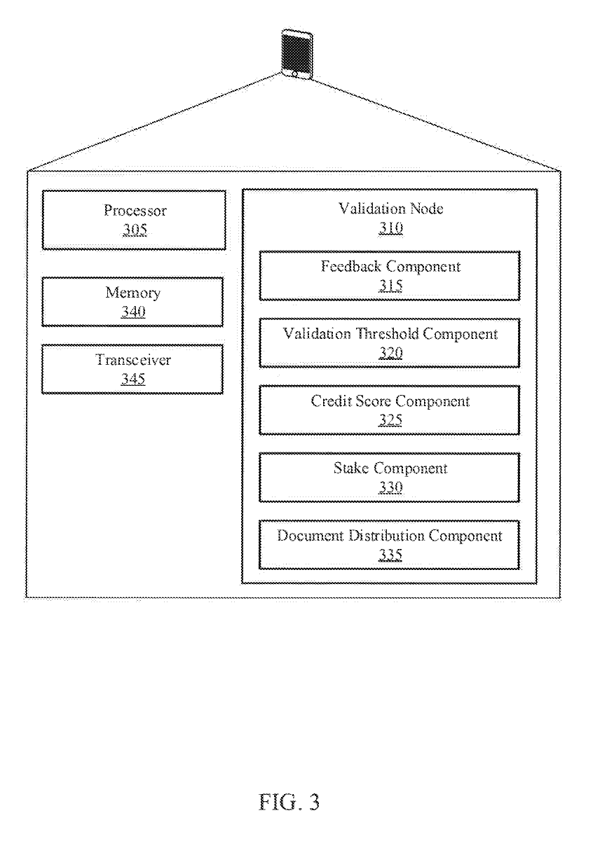

In some examples, validation server 105 may include validation node 110, database 115, and ledger 120. Validation node 110 may be an example of, or incorporate aspects of, validation node 210 and 310 as described with reference to FIGS. 2 and 3.

In some cases, the ledger 120 comprises a centralized ledger 120. In some cases, the ledger 120 comprises a decentralized ledger 120. In some cases, the block of transactions comprises a merkle tree of hashed transactions. User device 130 may be an example of, or incorporate aspects of, user device 205 as described with reference to FIG. 2.

A centralized credit network may use a server or other node with different capabilities than a user. The centralized credit network may also maintain a cloud 125 network on which many users may access and share data. A validation server 105 may contain a database 115 on the network of users including a credit score, a ledger 120 to maintain transaction history, and profile information for each user.

A validation node 110 may take voting data from multiple peers on a network to determine if a completed task has been approved, rejected, declined, or otherwise. Once determined, this transaction data may be added to a publicly (or privately) accessible ledger 120.

FIG. 2 illustrates an example of a decentralized credit network that supports peer verification of task completion in accordance with aspects of the present disclosure. The decentralized credit network may contain one or more user devices 205. User device 205 may be an example of, or incorporate aspects of, user device 130 as described with reference to FIG. 1. In a decentralized network, validation of transactions and maintenance of a ledger of transactions may be decentralized at numerous user devices 205 (e.g., using a blockchain). In some cases, the validation nodes are collocated with the user application (i.e., the application via which users submit and verify transactions). In other cases, the validation nodes may be separate from the user application.

Peer-to-peer networking may describe a distributed application architecture that splits workloads or tasks between multiple users on a network, known as peers. The use of a peer-to-peer system allows multiple users to manage the system in a decentralized manner, preventing a single point of failure. Peers may share data or tasks among themselves, and are also both suppliers and consumers of resources. In this way, peer nodes function both as clients and servers to other peers in the network. A decentralized credit network may operate without a single point of failure.

In some examples, user device 205 may include validation node 210. Validation node 210 may be an example of, or incorporate aspects of, validation node 110 and 310 as described with reference to FIGS. 1 and 3.

A credit computation system using a ledger to maintain a credit score for multiple users may be used to verify a user's credibility and trustworthiness. A user may affirm their completion of a task by proposing a validation transaction, during which other users may vote to accept or reject the completed task by a networked voting system. The credit computation system may implement a “blockchain” type data structure to manage the scores and validation transactions of multiple users. The credit computation system may provide a means for employers to evaluate the trustworthiness of a prospective employee.

FIG. 3 illustrates an example of a validation node 310 that supports peer verification of task completion in accordance with aspects of the present disclosure. FIG. 3 includes illustrations of processor 305, memory 340, and transceiver 345. A validation node may be located on a centralized server, on multiple decentralized servers, or on individual user devices.

In some examples, processor 305 may perform validation operations in conjunction with the validation node 310. Validation node 310 may be an example of, or incorporate aspects of, validation node 110 and 210 as described with reference to FIGS. 1 and 2. In some examples, validation node 310 may include feedback component 315, validation threshold component 320, credit score component 325, stake component 330, and document distribution component 335.

Feedback component 315 may determine a validation factor for a peer of the plurality of peers based at least in part on the plurality of feedback indicators; display a plurality of feedback options to the plurality of peers, wherein the plurality of feedback options comprises an approve option, a reject option, a decline option, a report option, or any combination thereof, and wherein each of the plurality of feedback indicators corresponds to one of the plurality of feedback options; determine a number of feedback indicators received from a peer of the plurality of peers during a time period, wherein the one or more documents are transmitted to the user based at least in part on the number of feedback indicators received from the user during the time period; identify a category of the transaction, wherein the plurality of peers are selected based at least in part on the category; and identify a description of the transaction.

In some cases, the validation factor for the user is based on whether a feedback indicator received from the user is consistent with other feedback indicators of the plurality of feedback indicators. In some cases, the transaction comprises a task, a job, a gig, a sales transaction, a project, or any combination thereof. In some cases, the one or more documents comprise one or more photographs, digital images, text documents, or any combination thereof. In some cases, the plurality of feedback indicators comprise a number of approve indicators and a number of reject indicators, and wherein the update factor is based on a comparison of the number of approve indicators and the number of reject indicators.

Validation threshold component 320 may receive a plurality of feedback indicators from the plurality of peers based on the one or more documents, wherein at most one of the plurality of feedback indicators is received from each of the plurality of peers; record the transaction among a block of transactions in a ledger; identify a feedback threshold for a time period; determine a feedback number based on a number of feedback indications, a number of approve indications, a number of reject indications, or any combination thereof provided by the user during the time period; determine whether the feedback number exceeds the feedback threshold; and select an activity status for the user based at least in part on whether the feedback number exceeds the feedback threshold.

Validation threshold component 320 may also identify a threshold number of transactions for the user; identify a number of transactions posted for review for the user during a time period; verify whether the number of transactions exceeds the threshold number of transactions, wherein transmitting the one or more documents is based at least in part on the verification; determine that a verification time period has passed after transmitting the one or more documents, wherein determining the update factor is based at least in part on determining that the verification time period has passed; and determine that a threshold number of the plurality of feedback indicators has been received, wherein determining the update factor is based at least in part on determining that the threshold number of the plurality of feedback indicators has been received.

Credit score component 325 may determine an update factor based on the plurality of feedback indicators; update a credit score of a user based on the update factor; update the corresponding credit score for the user based on the validation factor; determine the credit score based at least in part on a time period for using an application, a validation history, a number of accounts, a number of completed transactions, a set of transaction categories, or any combination thereof; determine a provisional update factor based on transaction; determine a provisional credit score for the user based on the provisional update factor; display the provisional credit score to the user prior to updating the credit score based on the update factor; and adjust the credit score based on the activity status. In some cases, each of the plurality of peers has a corresponding credit score.

Stake component 330 may identify one or more target documents and a target time period; transmit the one or more target documents to one or more candidate users; and receive the one or more documents within the target time period in response to transmitting the one or more target documents, and wherein the feedback indicators represent feedback regarding whether the one or more documents match the one or more target documents.

Document distribution component 335 may identify one or more documents indicating that a transaction is complete; transmit the one or more documents to a plurality of peers; and transmit the description to the plurality of peers, wherein the plurality of feedback indicators are based at least in part on the description.

A feedback component 315 may allow a user to upload one or more documents with a description to propose a transaction to the network. This proposed transaction may then be sent to the validation component. The credit score component 325 may alter the credit score of a user.

A validation threshold component 320 may accrue input from other users for a certain timeframe or until a threshold number of users have voted. Once a threshold is reached, a finished transaction may be added to the ledger and sent to a credit score component 325. A credit score component 325 may receive transaction data and change a user's credit score.

A stake component 330 may allow a user differentiated from other users in the network to request a task for completion. The user with the stake component 330 may have differing permissions and access levels from the other users. The stake component 330 may impose parameters, such as a time limit, on the request for the task from other users.

The credit score of a user may be determined by the user's validation history, their time on the network, their number of accounts, the diversity of tasks completed, etc. An initial credit score may be determined by a third party. The credit score may also be influenced by certain achievements within the peer network, such achieving certain numbers of validation transactions, having a larger network, etc. The credit score may be lowered for failing to validate a certain number of peers within a timeframe, or for uploading non-task related documents.

If a proposed transaction fails to be validated by peers, the user who submitted the original proposal may lose points on their credit score. In some cases, only the approve and reject validation options may have an effect on a user's credit score.

A user may be subject to certain rules and restrictions for validating transactions. In some cases, a user may be limited in the number of times they may approve a transaction, or they may be required to decline a number of transactions periodically. In some cases, a user may lose credit score for attempting to approve a transaction that is rejected by many other peers.

To become a networked user, a person may need to sign up for a new account using an identifying document, such as a driver's license. A user's account may be verified through a third party networking service. In some cases, a minimum validation history may be required before a user can submit a proposed transaction. Furthermore, a user may be required to maintain a level of validation activity in order to continue proposing transactions. Proposed transactions may be “non discriminatory”. “Non discriminatory” may refer to restricting details or identifiers about the user proposing the transaction from other peers.

A user may have a current credit score and a validated credit score. The current credit score may reflect all transaction history as well as pending transactions, i.e. the current credit score may assume all pending transactions will be validated. The validated credit score may reflect only all closed transactions of the user. The validated credit score may be the only score visible to other peers.

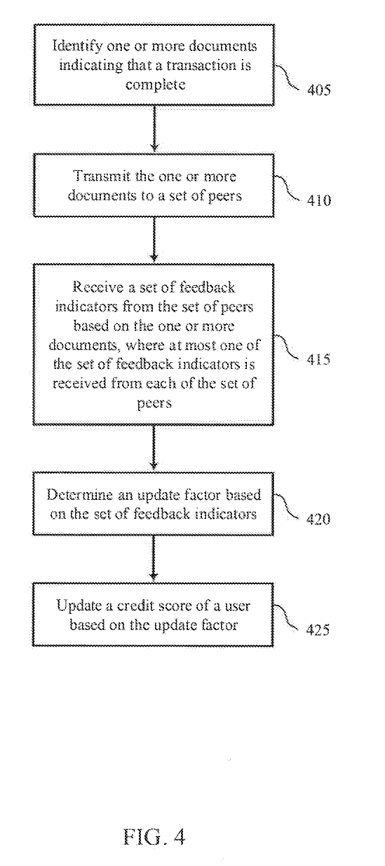

FIG. 4 illustrates an example of a process performed by a validation node for peer verification of task completion in accordance with aspects of the present disclosure. In some examples, a validation node may execute a set of codes to control functional elements of the validation node to perform the described functions. Additionally or alternatively, a validation node may use special-purpose hardware. These operations may be performed according to the methods and processes described in accordance with aspects of the present disclosure. For example, the operations may be composed of various substeps, or may be performed in conjunction with other operations described herein.

At block 405 the validation node may identify one or more documents indicating that a transaction is complete. In certain examples, aspects of the described operations may be performed by document distribution component 335 as described with reference to FIG. 3.

At block 410 the validation node may transmit the one or more documents to a plurality of peers. In certain examples, aspects of the described operations may be performed by document distribution component 335 as described with reference to FIG. 3. In some cases, the described operations may be performed in conjunction with a transceiver 345 as described with reference to FIG. 3.

At block 415 the validation node may receive a plurality of feedback indicators from the plurality of peers based on the one or more documents, wherein at most one of the plurality of feedback indicators is received from each of the plurality of peers. In certain examples, aspects of the described operations may be performed by validation threshold component 320 as described with reference to FIG. 3. In some cases, the described operations may be performed in conjunction with a transceiver 345 as described with reference to FIG. 3.

At block 420 the validation node may determine an update factor based on the plurality of feedback indicators. In certain examples, aspects of the described operations may be performed by credit score component 325 as described with reference to FIG. 3.

At block 425 the validation node may update a credit score of a user based on the update factor. In certain examples, aspects of the described operations may be performed by credit score component 325 as described with reference to FIG. 3.

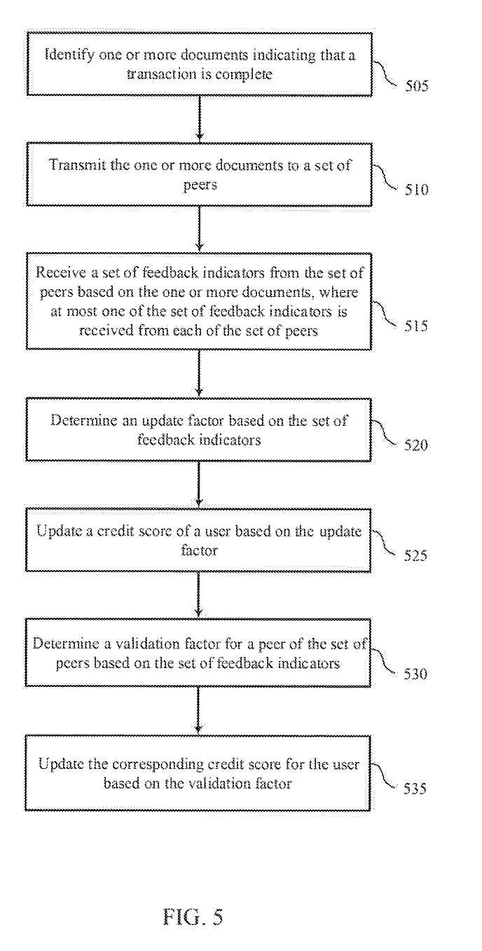

FIG. 5 illustrates an example of a process performed by a validation node for peer verification of task completion in accordance with aspects of the present disclosure. In some examples, a validation node may execute a set of codes to control functional elements of the validation node to perform the described functions. Additionally or alternatively, a validation node may use special-purpose hardware. These operations may be performed according to the methods and processes described in accordance with aspects of the present disclosure. For example, the operations may be composed of various substeps, or may be performed in conjunction with other operations described herein.

At block 505 the validation node may identify one or more documents indicating that a transaction is complete. In certain examples, aspects of the described operations may be performed by document distribution component 335 as described with reference to FIG. 3.

At block 510 the validation node may transmit the one or more documents to a plurality of peers. In certain examples, aspects of the described operations may be performed by document distribution component 335 as described with reference to FIG. 3. In some cases, the described operations may be performed in conjunction with a transceiver 345 as described with reference to FIG. 3.

At block 515 the validation node may receive a plurality of feedback indicators from the plurality of peers based on the one or more documents, wherein at most one of the plurality of feedback indicators is received from each of the plurality of peers. In certain examples, aspects of the described operations may be performed by validation threshold component 320 as described with reference to FIG. 3. In some cases, the described operations may be performed in conjunction with a transceiver 345 as described with reference to FIG. 3.

At block 520 the validation node may determine an update factor based on the plurality of feedback indicators. In certain examples, aspects of the described operations may be performed by credit score component 325 as described with reference to FIG. 3.

At block 525 the validation node may update a credit score of a user based on the update factor. In certain examples, aspects of the described operations may be performed by credit score component 325 as described with reference to FIG. 3.

At block 530 the validation node may determine a validation factor for a peer of the plurality of peers based at least in part on the plurality of feedback indicators. In certain examples, aspects of the described operations may be performed by feedback component 315 as described with reference to FIG. 3.

At block 535 the validation node may update the corresponding credit score for the user based on the validation factor. In certain examples, aspects of the described operations may be performed by credit score component 325 as described with reference to FIG. 3.

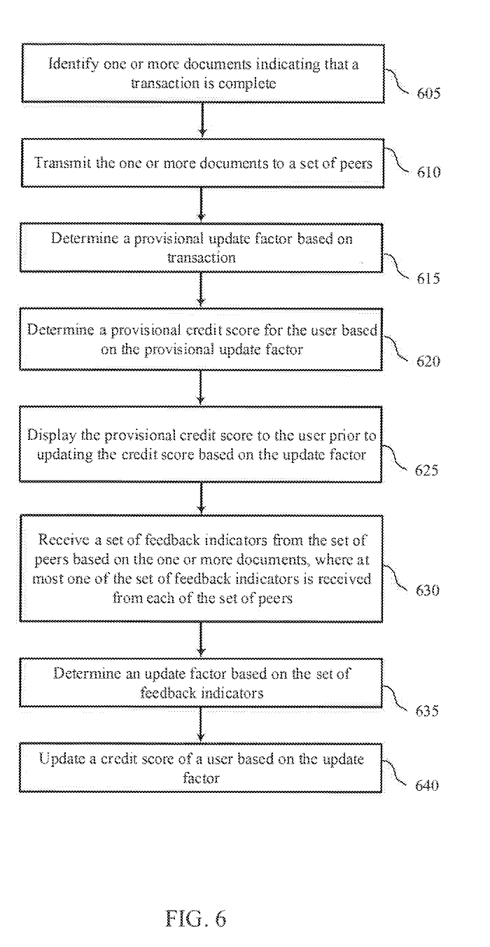

FIG. 6 illustrates an example of a process performed by a validation node for peer verification of task completion in accordance with aspects of the present disclosure. In some examples, a validation node may execute a set of codes to control functional elements of the validation node to perform the described functions. Additionally or alternatively, a validation node may use special-purpose hardware. These operations may be performed according to the methods and processes described in accordance with aspects of the present disclosure. For example, the operations may be composed of various substeps, or may be performed in conjunction with other operations described herein.

At block 605 the validation node may identify one or more documents indicating that a transaction is complete. In certain examples, aspects of the described operations may be performed by document distribution component 335 as described with reference to FIG. 3.

At block 610 the validation node may transmit the one or more documents to a plurality of peers. In certain examples, aspects of the described operations may be performed by document distribution component 335 as described with reference to FIG. 3. In some cases, the described operations may be performed in conjunction with a transceiver 345 as described with reference to FIG. 3.

At block 615 the validation node may determine a provisional update factor based on transaction. In certain examples, aspects of the described operations may be performed by credit score component 325 as described with reference to FIG. 3.

At block 620 the validation node may determine a provisional credit score for the user based on the provisional update factor. In certain examples, aspects of the described operations may be performed by credit score component 325 as described with reference to FIG. 3.

At block 625 the validation node may display the provisional credit score to the user prior to updating the credit score based on the update factor. In certain examples, aspects of the described operations may be performed by credit score component 325 as described with reference to FIG. 3.

At block 630 the validation node may receive a plurality of feedback indicators from the plurality of peers based on the one or more documents, wherein at most one of the plurality of feedback indicators is received from each of the plurality of peers. In certain examples, aspects of the described operations may be performed by validation threshold component 320 as described with reference to FIG. 3. In some cases, the described operations may be performed in conjunction with a transceiver 345 as described with reference to FIG. 3.

At block 635 the validation node may determine an update factor based on the plurality of feedback indicators. In certain examples, aspects of the described operations may be performed by credit score component 325 as described with reference to FIG. 3.

At block 640 the validation node may update a credit score of a user based on the update factor. In certain examples, aspects of the described operations may be performed by credit score component 325 as described with reference to FIG. 3.

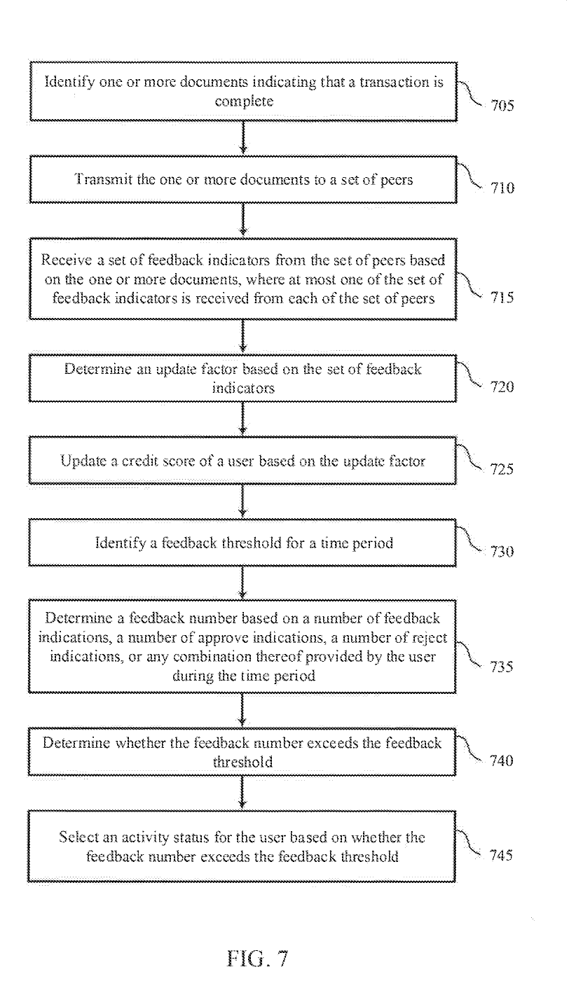

FIG. 7 illustrates an example of a process performed by a validation node for peer verification of task completion in accordance with aspects of the present disclosure. In some examples, a validation node may execute a set of codes to control functional elements of the validation node to perform the described functions. Additionally or alternatively, a validation node may use special-purpose hardware. These operations may be performed according to the methods and processes described in accordance with aspects of the present disclosure. For example, the operations may be composed of various substeps, or may be performed in conjunction with other operations described herein.

At block 705 the validation node may identify one or more documents indicating that a transaction is complete. In certain examples, aspects of the described operations may be performed by document distribution component 335 as described with reference to FIG. 3.

At block 710 the validation node may transmit the one or more documents to a plurality of peers. In certain examples, aspects of the described operations may be performed by document distribution component 335 as described with reference to FIG. 3. In some cases, the described operations may be performed in conjunction with a transceiver 345 as described with reference to FIG. 3.

At block 715 the validation node may receive a plurality of feedback indicators from the plurality of peers based on the one or more documents, wherein at most one of the plurality of feedback indicators is received from each of the plurality of peers. In certain examples, aspects of the described operations may be performed by validation threshold component 320 as described with reference to FIG. 3. In some cases, the described operations may be performed in conjunction with a transceiver 345 as described with reference to FIG. 3.

At block 720 the validation node may determine an update factor based on the plurality of feedback indicators. In certain examples, aspects of the described operations may be performed by credit score component 325 as described with reference to FIG. 3.

At block 725 the validation node may update a credit score of a user based on the update factor. In certain examples, aspects of the described operations may be performed by credit score component 325 as described with reference to FIG. 3.

At block 730 the validation node may identify a feedback threshold for a time period. In certain examples, aspects of the described operations may be performed by validation threshold component 320 as described with reference to FIG. 3.

At block 735 the validation node may determine a feedback number based on a number of feedback indications, a number of approve indications, a number of reject indications, or any combination thereof provided by the user during the time period. In certain examples, aspects of the described operations may be performed by validation threshold component 320 as described with reference to FIG. 3.

At block 740 the validation node may determine whether the feedback number exceeds the feedback threshold. In certain examples, aspects of the described operations may be performed by validation threshold component 320 as described with reference to FIG. 3.

At block 745 the validation node may select an activity status for the user based at least in part on whether the feedback number exceeds the feedback threshold. In certain examples, aspects of the described operations may be performed by validation threshold component 320 as described with reference to FIG. 3.

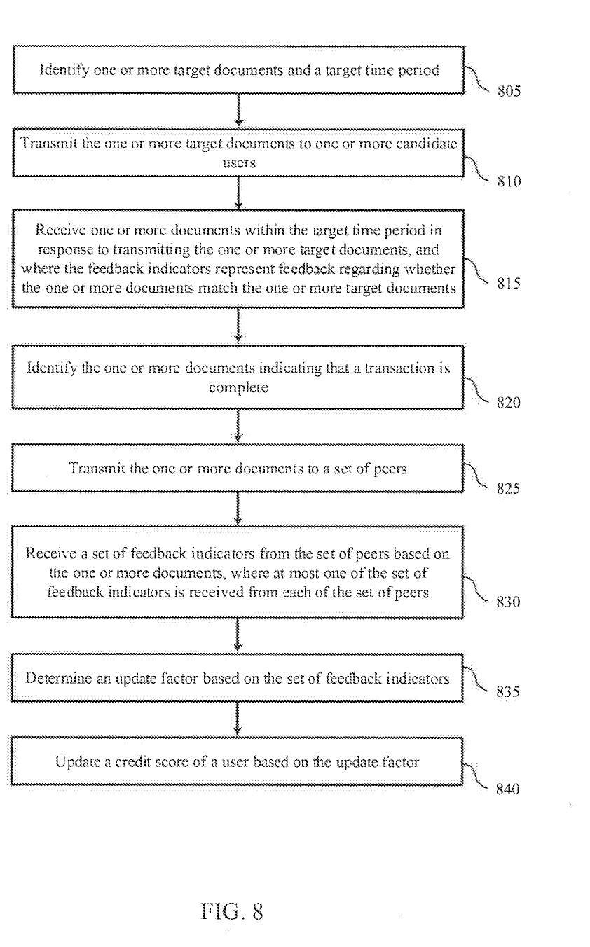

FIG. 8 illustrates an example of a process performed by a validation node for peer verification of task completion in accordance with aspects of the present disclosure. In some examples, a validation node may execute a set of codes to control functional elements of the validation node to perform the described functions. Additionally or alternatively, a validation node may use special-purpose hardware. These operations may be performed according to the methods and processes described in accordance with aspects of the present disclosure. For example, the operations may be composed of various substeps, or may be performed in conjunction with other operations described herein.

At block 805 the validation node may identify one or more target documents and a target time period. In certain examples, aspects of the described operations may be performed by stake component 330 as described with reference to FIG. 3.

At block 810 the validation node may transmit the one or more target documents to one or more candidate users. In certain examples, aspects of the described operations may be performed by stake component 330 as described with reference to FIG. 3. In some cases, the described operations may be performed in conjunction with a transceiver 345 as described with reference to FIG. 3.

At block 815 the validation node may receive the one or more documents within the target time period in response to transmitting the one or more target documents, and wherein the feedback indicators represent feedback regarding whether the one or more documents match the one or more target documents. In certain examples, aspects of the described operations may be performed by stake component 330 as described with reference to FIG. 3. In some cases, the described operations may be performed in conjunction with a transceiver 345 as described with reference to FIG. 3.

At block 820 the validation node may identify one or more documents indicating that a transaction is complete. In certain examples, aspects of the described operations may be performed by document distribution component 335 as described with reference to FIG. 3.

At block 825 the validation node may transmit the one or more documents to a plurality of peers. In certain examples, aspects of the described operations may be performed by document distribution component 335 as described with reference to FIG. 3. In some cases, the described operations may be performed in conjunction with a transceiver 345 as described with reference to FIG. 3.

At block 830 the validation node may receive a plurality of feedback indicators from the plurality of peers based on the one or more documents, wherein at most one of the plurality of feedback indicators is received from each of the plurality of peers. In certain examples, aspects of the described operations may be performed by validation threshold component 320 as described with reference to FIG. 3. In some cases, the described operations may be performed in conjunction with a transceiver 345 as described with reference to FIG. 3.

At block 835 the validation node may determine an update factor based on the plurality of feedback indicators. In certain examples, aspects of the described operations may be performed by credit score component 325 as described with reference to FIG. 3.

At block 840 the validation node may update a credit score of a user based on the update factor. In certain examples, aspects of the described operations may be performed by credit score component 325 as described with reference to FIG. 3.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a DSP, an ASIC, an FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise RAM, ROM, electrically erasable programmable read only memory (EEPROM), compact disk (CD) ROM or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, digital subscriber line (DSL), or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for verifying task completion, comprising:
identifying one or more documents indicating that a transaction is complete;
transmitting the one or more documents to a plurality of peers;
receiving a plurality of feedback indicators from the plurality of peers based on the one or more documents, wherein at most one of the plurality of feedback indicators is received from each of the plurality of peers;
determining an update factor based on the plurality of feedback indicators; and
updating a credit score of a user based on the update factor.

2. The method of claim 1, wherein:
each of the plurality of peers has a corresponding credit score.

3. The method of claim 2, further comprising:
determining a validation factor for a peer of the plurality of peers based at least in part on the plurality of feedback indicators; and
updating the corresponding credit score for the user based on the validation factor.

4. The method of claim 3, wherein:
the validation factor for the user is based on whether a feedback indicator received from the user is consistent with other feedback indicators of the plurality of feedback indicators.

5. The method of claim 1, wherein:
the transaction comprises a task, a job, a gig, a sales transaction, a project, or any combination thereof.

6. The method of claim 1, wherein:
the one or more documents comprise one or more photographs, digital images, text documents, or any combination thereof.

7. The method of claim 1, further comprising:
displaying a plurality of feedback options to the plurality of peers, wherein the plurality of feedback options comprises an approve option, a reject option, a decline option, a report option, or any combination thereof, and wherein each of the plurality of feedback indicators corresponds to one of the plurality of feedback options.

8. The method of claim 1, wherein:
the plurality of feedback indicators comprise a number of approve indicators and a number of reject indicators, and wherein the update factor is based on a comparison of the number of approve indicators and the number of reject indicators.

9. The method of claim 1, further comprising:
identifying a category of the transaction, wherein the plurality of peers are selected based at least in part on the category.

10. The method of claim 1, further comprising:
determining the credit score based at least in part on a time period for using an application, a validation history, a number of accounts, a number of completed transactions, a set of transaction categories, or any combination thereof.

11. The method of claim 1, further comprising:
identifying a description of the transaction; and
transmitting the description to the plurality of peers, wherein the plurality of feedback indicators are based at least in part on the description.

12. The method of claim 1, further comprising:
determining a provisional update factor based on transaction;
determining a provisional credit score for the user based on the provisional update factor; and
displaying the provisional credit score to the user prior to updating the credit score based on the update factor.

13. The method of claim 1, further comprising:
identifying a feedback threshold for a time period;
determining a feedback number based on a number of feedback indications, a number of approve indications, a number of reject indications, or any combination thereof provided by the user during the time period;
determining whether the feedback number exceeds the feedback threshold; and
selecting an activity status for the user based at least in part on whether the feedback number exceeds the feedback threshold.

14. The method of claim 13, further comprising:
adjusting the credit score based on the activity status.

15. The method of claim 1, further comprising:
identifying one or more target documents and a target time period;
transmitting the one or more target documents to one or more candidate users; and
receiving the one or more documents within the target time period in response to transmitting the one or more target documents, and wherein the feedback indicators represent feedback regarding whether the one or more documents match the one or more target documents.

16. The method of claim 1, further comprising:
identifying a threshold number of transactions for the user;
identifying a number of transactions posted for review for the user during a time period; and
verifying whether the number of transactions exceeds the threshold number of transactions, wherein transmitting the one or more documents is based at least in part on the verification.

17. The method of claim 1, further comprising:
determining that a verification time period has passed after transmitting the one or more documents, wherein determining the update factor is based at least in part on determining that the verification time period has passed.

18. The method of claim 1, further comprising:
determining that a threshold number of the plurality of feedback indicators has been received, wherein determining the update factor is based at least in part on determining that the threshold number of the plurality of feedback indicators has been received.

19. A non-transitory computer readable medium storing code for verifying task completion, the code comprising instructions executable by a processor to:
identify one or more documents indicating that a transaction is complete;
transmit the one or more documents to a plurality of peers;
receive a plurality of feedback indicators from the plurality of peers based on the one or more documents, wherein at most one of the plurality of feedback indicators is received from each of the plurality of peers;
determine an update factor based on the plurality of feedback indicators; and
update a credit score of a user based on the update factor.

20. An apparatus for verifying task completion, comprising:
a processor; and
a memory storing instructions and in electronic communication with the processor, the processor being configured to execute the instructions to:
identify one or more documents indicating that a transaction is complete;
transmit the one or more documents to a plurality of peers;
receive a plurality of feedback indicators from the plurality of peers based on the one or more documents, wherein at most one of the plurality of feedback indicators is received from each of the plurality of peers;
determine an update factor based on the plurality of feedback indicators; and
update a credit score of a user based on the update factor.
